(19) United States
(12) Patent Application Publication
(10) Pub. No.: US 2013/0199671 A1
(43) Pub. Date: Aug. 8, 2013

(54) Work piece Guide for Woodworking Machines

(71) Applicant: Kelvin Craig Brodersen, Fairbanks, AK (US)

(72) Inventor: Kelvin Craig Brodersen, Fairbanks, AK (US)

(21) Appl. No.: 13/366,289

(22) Filed: Feb. 4, 2012

(51) Int. Cl. B23Q 3/10; B27C 5/06

(52) U.S. Cl. 144/253.6

(57) ABSTRACT

An improved design for a featherboard. The featherboard exerts lateral pressure against a work piece, keeping it pressed against a guide fence of a power tool for improved accuracy of cut. The featherboard consists of a bracket, which can be fixed to and removed from the worktable without tools. It has one or more attachment posts. The bracket also has a guide that accepts a featherboard arm that can be locked in place with a locking knob when it is in the desired position. At the end of the featherboard arm is one or more flexible plates with guide marks. When the featherboard arm is properly positioned the flexible plate(s) is/are pressed into the work piece to hold the work piece against the guide fence and to prevent kick back of the work piece by the saw.

### CROSS REFERENCE TO RELATED APPLICATIONS

This application claims benefit of Provisional application 61/426,591 filed Feb. 4, 2011.

### STATEMENT REGARDING FEDERALLY SPONSORED RESEARCH AND DEVELOPMENT

Not Applicable

### BACKGROUND OF THE INVENTION

1. Field of the invention

This invention relates to the field of accessories for table saws, band saws, router tables and other woodworking machinery, and particularly to featherboards for table saws, band saws, router tables and other woodworking machinery.

2. Description of the Prior Art

A featherboard is a device used when working with stationary routers, table saws or band saws. A featherboard helps ensure an accurate cut by pressing a work piece against the table or the guide fence as the work piece moves past the cutting blade. Additionally, a properly designed featherboard is a safety device, which prevents the work piece from kicking back at the operator should the cutting blade bind up in the work piece. Generally, a featherboard that presses a work piece to the table is secured to the guide fence and a featherboard that presses a work piece to the guide fence is secured to the table. See, for example, U.S. Pat. No. 481,983 (1892), U.S. Pat. No. 534,447 (1895), U.S. Pat. No. 1,022,176 (1912), U.S. Pat. No. 2,612,914 (1952), U.S. Pat. No. 2,699,804 (1955), and U.S. Pat. No. 6,619,347 (2003).

The most common means by which a featherboard is secured to the table is to position it in the miter slot or T-slot and lock it in place. See, for example, U.S. Pat. No. 2,722,247 (1955) and U.S. Pat. No. 4,476,757 (1984). The slot is typically within 6 inches of the cutting blade, which limits the width of the work piece that can be used with the featherboard. A featherboard may also be held in place with a strong magnet. This allows for a wider work piece than the miter slot featherboard because the magnet can be positioned anywhere on the table, but only if the table is flat and ferrous. Since many tabletops are manufactured from aluminum, and side extension tables may be made from wood, aluminum, corrugated steel or even plastic, especially if home built, this device will not work with all machines.

U.S. Pat. No. 3,457,972 (1969) describes a long-reach featherboard that mounts to the worktable using a spline pin that fits into a spline receptacle. The entire length of the arm functions as the spring that holds the work piece to the guide fence.

### BRIEF DESCRIPTION OF THE INVENTION

The invention is an improved woodworking accessory for keeping a work piece pressed tightly against the guide fence on a table saw, stationary router or band saw. The invention features a unique bracket that allows the invention to be quickly and securely attached to a worktable without tools. It also has an arm that is held in the bracket. At the end of the arm is a flexible plate that acts as a spring to assert pressure against a work piece moving through a saw blade, for example.

### BRIEF DESCRIPTION OF THE DRAWINGS

FIG. 1 is an isometric view of the featherboard edge-mounted on the extension wing of a table saw.

FIG. 2 is a side view of the featherboard arm and flexible plate as fully assembled.

FIG. 2a is an exploded view of the featherboard arm and flexible plate.

FIG. 3a is top view showing the featherboard arm with one flexible plate.

FIG. 3b is top view showing the featherboard arm with three flexible plates in a triangle configuration.

FIG. 3c is a top view showing the featherboard arm with three flexible plates in a step configuration.

FIG. 3d is top view showing the featherboard arm with two flexible plates, spaced apart.

FIG. 4 is an exploded view of a single-hole mounting bracket located at the edge of the worktable.

FIG. 5 is an exploded view of a 3-hole mounting bracket located away from the edge of the worktable.

FIG. 6 is a partially exploded side view of a 3-hole mounting bracket installed on the edge of a worktable.

### DETAILED DESCRIPTION OF THE INVENTION

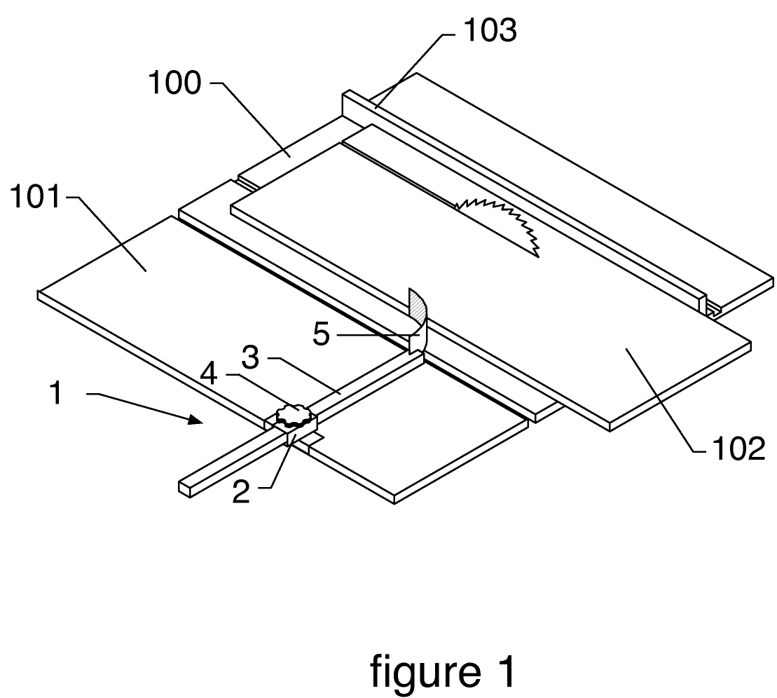

FIG. 1 shows the featherboard 1 installed on the extension wing 101 of a table saw 100. The featherboard has two main parts. There is a featherboard bracket 2, which is secured to the worktable, as discussed below, and holds the featherboard arm 3 in place. The featherboard arm 3 is positioned to engage the edge of the work piece 102 and is fixed in place with a locking knob 4. At the distal end of the arm 3 are one or more flexible plates 5 (see below). The flexible plates 5, when bent, act as a spring that keeps pressure on the work piece 102 so that it is always flush against the guide fence 103. Once engaged with the flex plate 5, the work piece can only move forward, which is a safety feature that prevents kick back of the work piece.

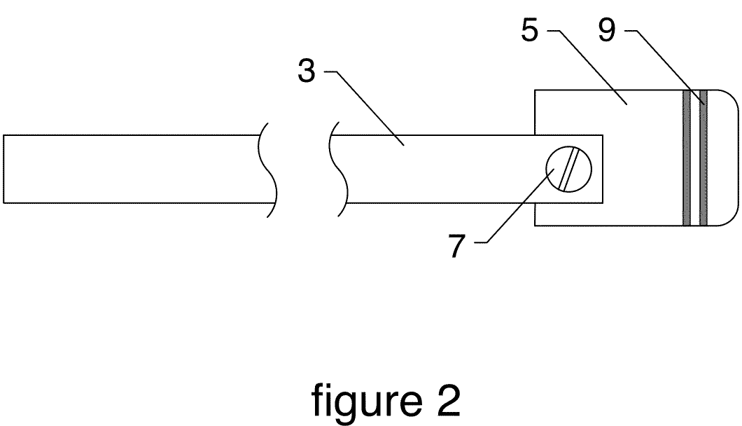

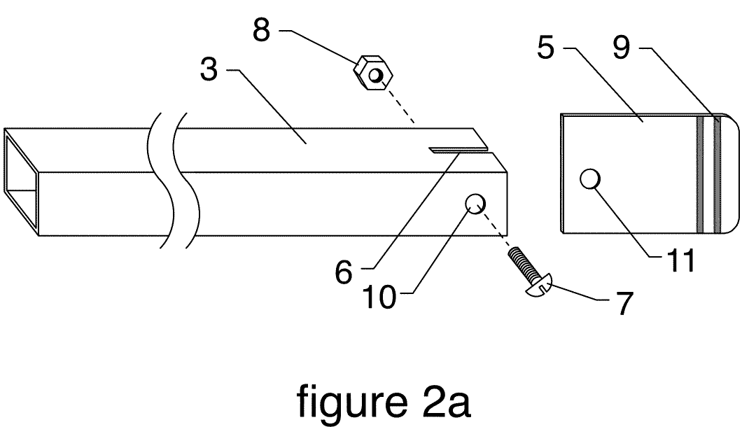

FIG. 2 is a side view of the featherboard arm 3 and flexible plate 5 as fully assembled. In this view, only one flexible plate is shown. The featherboard arm 3 is a rigid arm that has a slot 6 formed at its distal end as shown in FIG. 2a. A fastener, preferably a screw 7 and nut 8 (FIG. 2a) are used to hold the flexible plate 5. Note that guide marks 9 that are formed at the end of the flexible plate 5 help position the featherboard arm with respect to the work piece.

The flexible plate 5 is made of thin, flexible material. The featherboard arm 3 must be sufficiently rigid that it does not bend as it presses the work piece against the guide fence. In the preferred embodiment, square aluminum pipe ¾″×¾″ is the preferred material because it slides freely inside the 1″ square steel pipe made (used as a bracket, see below) with little free play. The featherboard arm 3 can be made any length and can be sized to the width of a particular table saw.

FIG. 2a is an exploded view of the featherboard arm 3 and a single flexible plate 5. As discussed above, a slot 6 is cut in the distal end of the featherboard arm 3 to receive the flexible plate 5. A hole 10 is drilled through the end of the featherboard arm 3 for the screw 7. A corresponding hole 11 is formed in the back end of the flexible plate 5. The machine screw 7 and a hex nut 8 are used to fix the flexible plate 5 to the featherboard arm 3. Should the flexible plate be damaged it can be easily removed and a new flexible plate installed.

In the preferred embodiment, individual flexible plates are made from a material that is both flexible and tough, such as 1/16″ LEXAN. In this figure, the guide marks 9 on the flex plate 5 are shown. As noted above, they help position the featherboard arm 3 with respect to the work piece 102.

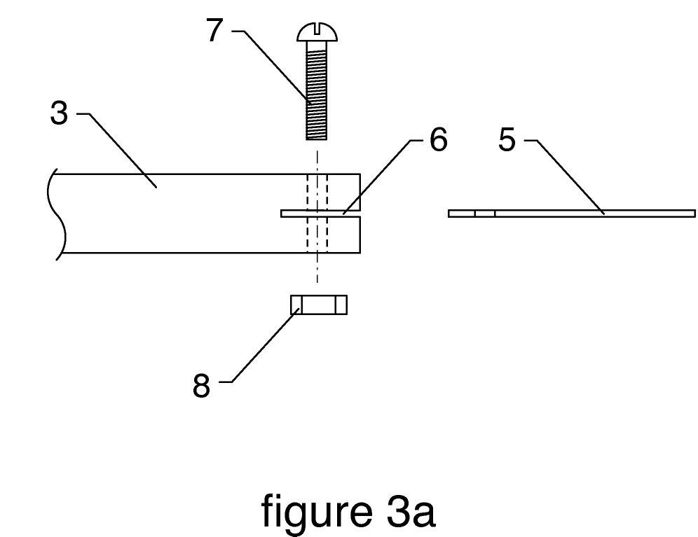

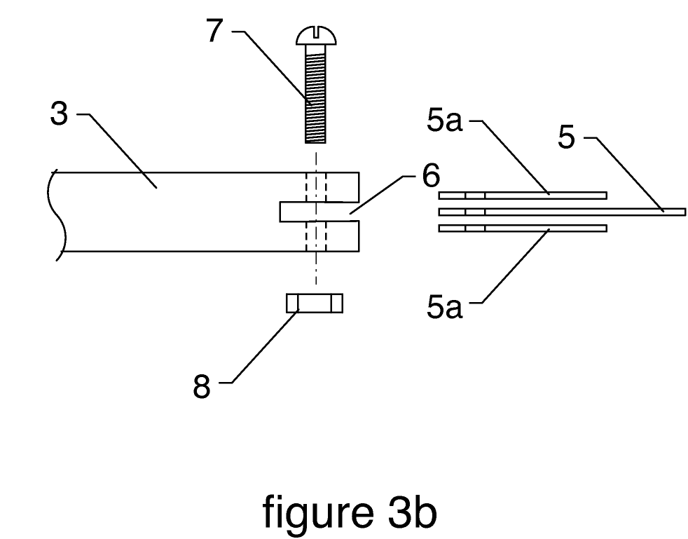

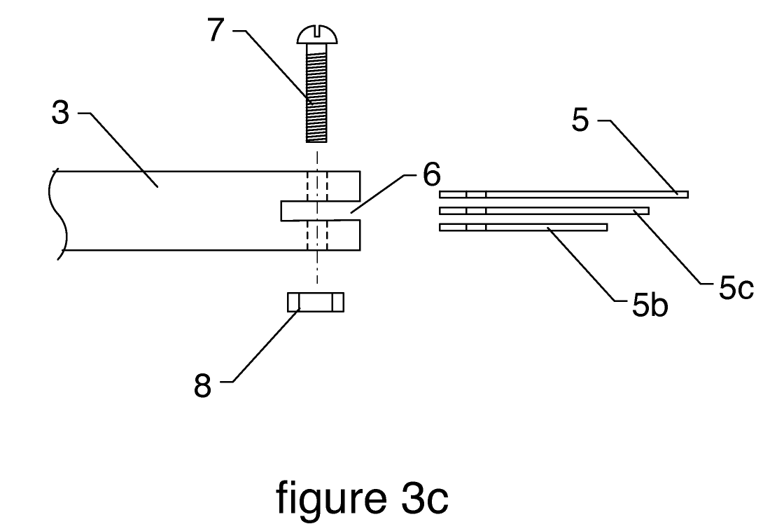

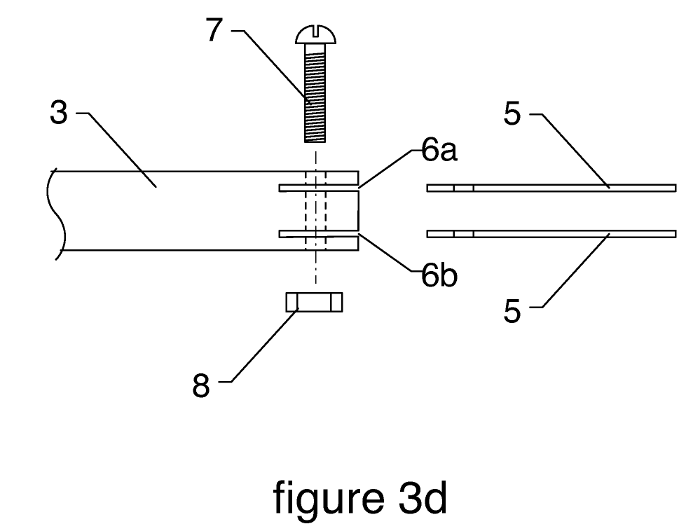

FIGS. 3a-3d show several configurations that achieve various degrees of flexibility and work piece pressure. FIG. 3a is an exploded top view showing the featherboard arm with one flexible plate. This is a top view of the configuration shown in FIG. 2.

FIG. 3b is an exploded top view showing the featherboard arm with three flexible plates in a pyramid configuration. In this view, the featherboard arm 3 has a wider slot 6 to accommodate three flexible plates. The center flexible plate 5 is the same length as that of the single flexible plate of FIG. 2. On either side of that plate 5 are two shorter flexible plates 5a. As before, the flexible plates are secured with a screw 7 and hex nut 8.

FIG. 3c is an exploded top view showing the featherboard arm with three flexible plates in a step configuration. Here, the featherboard arm 3 also has a wider slot 6 to accommodate three flexible plates. The top most flexible plates 5b and 5c are shown each being shorter than the last. As before, the flexible plates are secured with a screw 7 and hex nut 8.

FIG. 3d is an exploded top view showing the featherboard arm with two flexible plates, spaced apart. In this configuration, the featherboard arm 3 has two slots 6a and 6b that are a single width wide and are spaced apart as shown. Two, equal length, flexible plates 5 are placed in the slots and are secured with a screw 7 and hex nut 8, as before.

The edges of the flexible plate presses into the side of the work piece, preventing it from moving backward. This is an additional safety feature that further eliminates kickback.

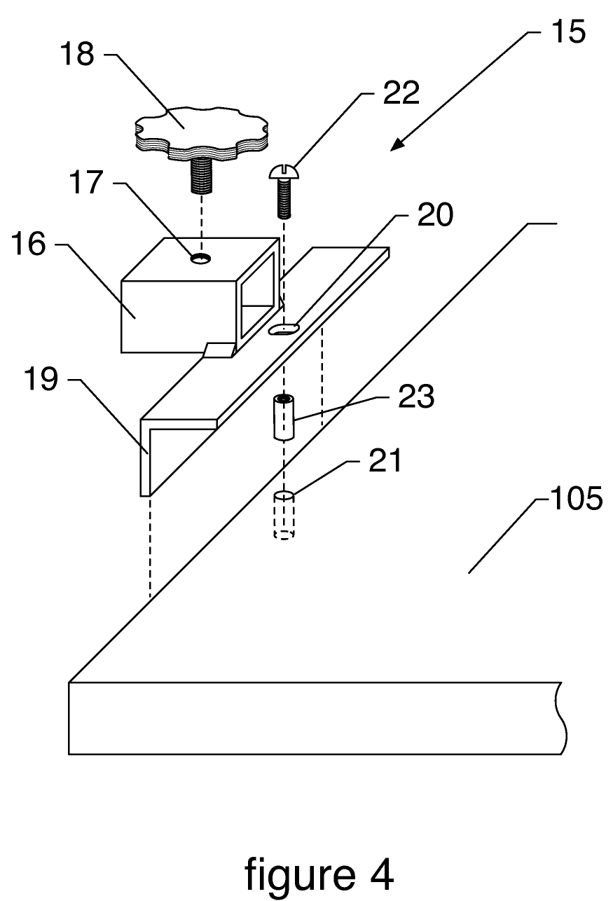

FIG. 4 is an exploded view of a single-hole mounting bracket located at the edge of the worktable. This first embodiment of the mounting bracket 15 is designed to mount on the edge of a worktable 105. In the preferred embodiment, the mounting bracket 15 includes an arm guide 16 that consists of a piece of steel pipe 1″×1″ square and 1.5″ long. A hole 17 is drilled and tapped in the top of the arm guide to receive a threaded post of a locking knob 18. The featherboard arm 3 is placed in this bracket for use (see FIG. 1). The position of the featherboard arm 3 can be set using the locking knob 18.

A bracket mounting piece 19 consists of a piece of 1″×1″ steel angle stock that is 4″ long. The purpose of the bracket-mounting piece is to fit securely over the edge of the worktable to provide mechanical stability to the featherboard. The arm guide 16 is welded to the bracket edge as shown. There is an elongated slot 20 in the bracket-mounting piece 19 as shown.

To install the mounting bracket 15, the following steps are used. First, place the bracket-mounting piece 19 on the edge of the worktable 105 in the desired location with the bracket mounting piece 19 flush with the worktable edge. In this position, the center of the elongated slot 20 will be ½″ from the edge of the table. Second, mark the location of the hole. Third, drill a ¼″ diameter vertical hole 21 into the worktable on the mark. Fourth, a machine screw 22 is passed through the elongated slot 20 in the bracket edge and then loosely threaded into a ¼″ diameter tapped standoff 23. The machine screw can be moved back and forth within the slot so that the bracket-mounting piece 19 is perfectly flush with the table edge when the standoff is placed in hole 21. Finally, the machine screw is tightened to fix the position of the standoff

Once the standoff 23 is secured to the bracket-mounting piece 19 it may then be lifted off the table and then returned to its working position at any time without any tools. The combination of the bracket edge and the standoff make the bracket very stable and rugged under any anticipated load.

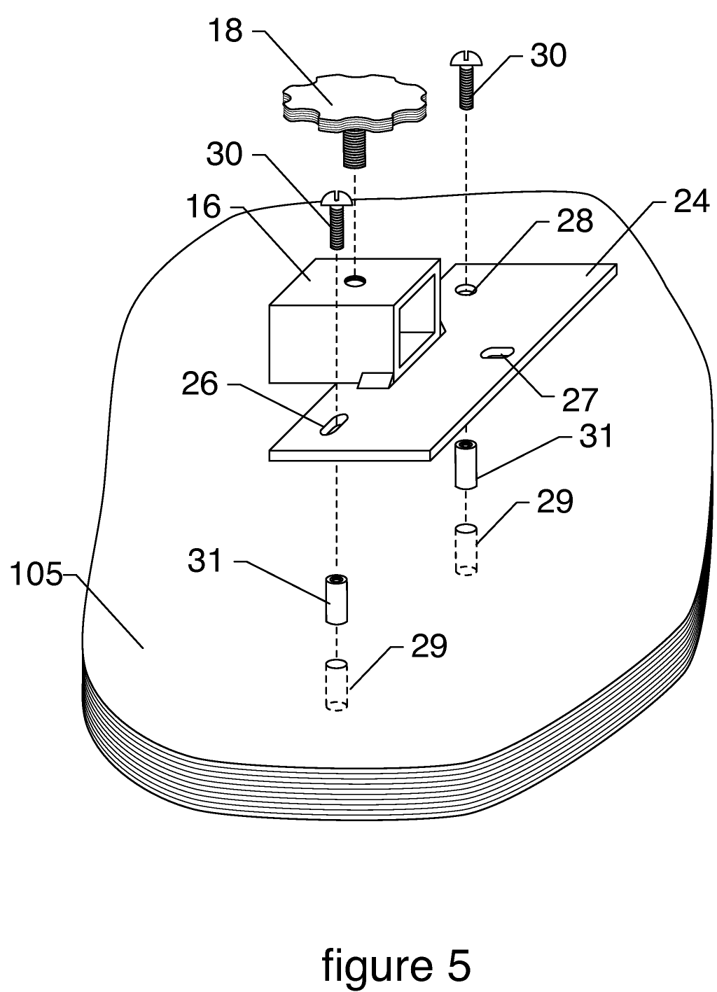

FIG. 5 shows a second embodiment of the mounting bracket, which is designed to mount away from the edge of the worktable 105. In this embodiment, the arm guide 16 is welded to a bracket plate 24 made from a ⅛″ thick flat steel piece, which is 4″ wide by 2″ deep. There are three holes 26, 27 and 28 in the bracket plate. Holes 26 and 27 are elongated and hole 28 is circular. The bracket plate is placed on the work table 105 in the desired location and marks are made on the work table in the center of holes 26 and 28. A ¼″ hole 29 is drilled into the worktable at each mark. A machine screw 30 is passed through holes 26 and 28 in the bracket plate 24 and then loosely threaded into ¼″ diameter standoffs 31. The elongated hole 26 makes it possible for both standoffs to fit into the holes in the table even if the holes are not exactly on the marks. The machine screws are then tightened and the standoffs are then secured to the bracket plate 24. As in the case of the first embodiment, the bracket plate 24 may be placed on and off the worktable, precisely and securely without tools.

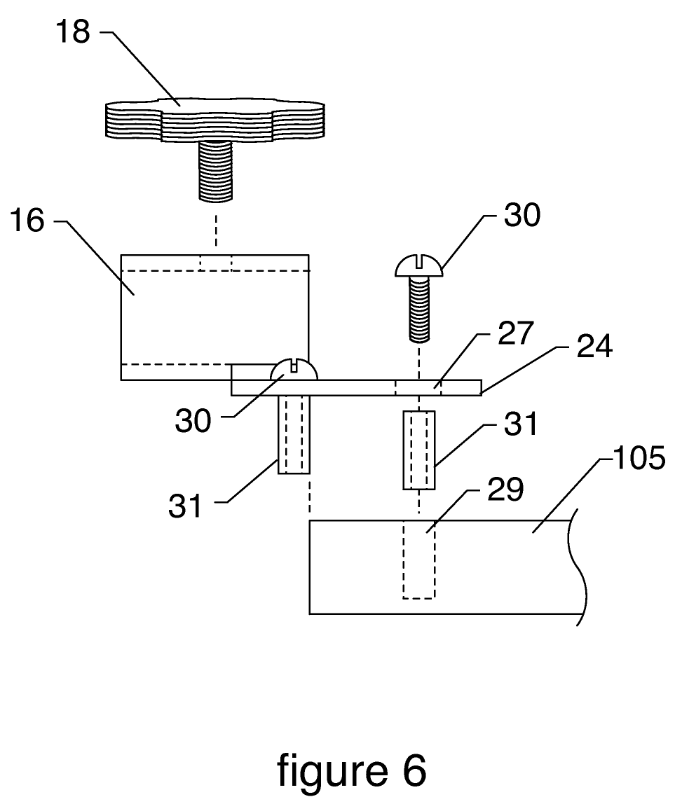

The bracket plate 24 may also be installed on the edge of a worktable 105 as shown in FIG. 6. Here, the machine screws 30 secured in holes 26 and 28 act as a bracket edge and are located flush with the work table edge in the desired location. The center of the third hole 27 (which is elongated) is marked on the table and a single ¼″ hole is drilled into the worktable. A third machine screw 30 is passed through the elongated hole 27 in the bracket plate and then loosely threaded into a standoff 31. As before, the machine screw can be moved back and forth within the elongated hole 27 so that the fixed standoffs are perfectly flush with the table edge when the loose standoff sits in the newly drilled hole, at which point the third machine screw is securely tightened. Once the third standoff 31 is secured to the plate, the plate can be removed without tools.

Although the drawing figures show this tool in use with a table saw, the tool can be used equally well with band saws, router tables and other woodworking machinery in exactly the same way as illustrated. Once the tool is attached to the particular machine bed, the position of the featherboard arm 3 can be adjusted for a particular work piece and machine and the operation of woodworking can begin.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

I claim:

1. A work piece guide for woodworking machines having a worktable comprising:
a) a rigid featherboard arm having a proximate end and a distal end and a length, said featherboard arm also having a slot formed in said distal end;
b) a flexible plate, being generally rectangular and being removably installed in the slot formed in the said featherboard arm;
c) a means for temporarily securing said flexible plate in said slot of said featherboard arm; and
d) a means for temporarily securing said featherboard arm to said worktable.

2. The work piece guide of claim 1 wherein the flexible plate further comprises at least one guide mark, formed thereon.

3. The work piece guide of claim 1 wherein the means for temporarily securing said featherboard arm to said worktable includes a means for lockably adjusting the position of said featherboard arm with respect to said worktable.

4. The work piece guide of claim 1 wherein the means for temporarily securing said featherboard arm to said worktable comprises:
a) an angled mounting bracket having one or more mounting holes formed therein;
b) an arm guide, secured to said angled mounting bracket for slidably retaining said featherboard arm, said arm guide having a threaded hole formed therein; and
c) a locking knob, having a threaded post formed thereon for threadably engaging the threaded hole on said arm guide, wherein when said threaded post on said locking knob engages said featherboard arm, said featherboard arm is locked in place.

5. The work piece guide of claim 4 further comprising one or more standoffs, in number equaling the number of mounting holes in said angled mounting bracket, adjustably secured to angled mounting bracket and extending downwards therefrom, whereby said standoffs engage a corresponding number of holes formed in said worktable such that when said standoffs are in said holes on said worktable, the work piece guide is firmly, yet temporarily, attached to said worktable.

6. The work piece guide of claim 1 wherein the means for temporarily securing said featherboard arm to said worktable comprises:
a) a flat mounting plate having a plurality of mounting holes formed therein;
b) an arm guide, secured to said flat mounting plate for slidably retaining said featherboard arm, said arm guide having a threaded hole formed therein; and
c) a locking knob, having a threaded post formed thereon for threadably engaging the threaded hole on said arm guide, wherein when said threaded post on said locking knob engages said featherboard arm, said featherboard arm is locked in place.

7. The work piece guide of claim 6 further comprising a plurality of standoffs, adjustably secured to flat mounting plate and extending downwards therefrom, whereby said standoffs engage a corresponding plurality of holes formed in said worktable such that when said standoffs are in said holes on said worktable, the work piece guide is firmly, yet temporarily, attached to said worktable.

8. A work piece guide for woodworking machines having a worktable comprising:
a) a rigid featherboard arm having a proximate end and a distal end and a length, said featherboard arm also having a slot formed in said distal end;
b) a plurality of flexible plates, being generally rectangular and being removably installed in the slot formed in the said featherboard arm;
c) a means for temporarily securing said plurality of flexible plates in said slot of said featherboard arm; and
d) a means for temporarily securing said featherboard arm to said worktable.

9. The work piece guide of claim 8 wherein the each of said plurality of flexible plates further comprises at least one guide mark, formed thereon.

10. The work piece guide of claim 8 wherein the means for temporarily securing said featherboard arm to said worktable includes a means for lockably adjusting the position of said featherboard arm with respect to said worktable.

11. The work piece guide of claim 8 wherein the means for temporarily securing said featherboard arm to said worktable comprises:
a) an angled mounting bracket having one or more mounting holes formed therein;
b) an arm guide, secured to said angled mounting bracket for slidably retaining said featherboard arm, said arm guide having a threaded hole formed therein; and
c) a locking knob, having a threaded post formed thereon for threadably engaging the threaded hole on said arm guide, wherein when said threaded post on said locking knob engages said featherboard arm, said featherboard arm is locked in place.

12. The work piece guide of claim 11 further comprising one or more standoffs, in number equaling the number of mounting holes in said angled mounting bracket, adjustably secured to angled mounting bracket and extending downwards therefrom, whereby said standoffs engage a corresponding number of holes formed in said worktable such that when said standoffs are in said holes on said worktable, the work piece guide is firmly, yet temporarily, attached to said worktable.

13. The work piece guide of claim 8 wherein the means for temporarily securing said featherboard arm to said worktable comprises:
a) a flat mounting plate having a plurality of mounting holes formed therein;
b) an arm guide, secured to said flat mounting plate for slidably retaining said featherboard arm, said arm guide having a threaded hole formed therein; and
c) a locking knob, having a threaded post formed thereon for threadably engaging the threaded hole on said arm guide, wherein when said threaded post on said locking knob engages said featherboard arm, said featherboard arm is locked in place.

14. The work piece guide of claim 13 further comprising a plurality of standoffs, adjustably secured to flat mounting plate and extending downwards therefrom, whereby said standoffs engage a corresponding plurality of holes formed in said worktable such that when said standoffs are in said holes on said worktable, the work piece guide is firmly, yet temporarily, attached to said worktable.

15. A work piece guide for woodworking machines having a worktable comprising:
a) a rigid featherboard arm having a proximate end and a distal end and a length, said featherboard arm also having a first slot formed in said distal end and a second slot formed in said distal end, being spaced apart from said first slot;
b) a first flexible plate, being generally rectangular and being removably installed in said first slot formed in the said featherboard arm;
c) a second flexible plate, being generally rectangular and being removably installed in said second slot formed in the said featherboard arm;
d) a means for temporarily securing said flexible plate in said slot of said featherboard arm; and
e) a means for temporarily securing said featherboard arm to said worktable.

16. The work piece guide of claim 15 wherein first and second flexible plates further comprise at least one guide mark, formed thereon.

17. The work piece guide of claim 15 wherein the means for temporarily securing said featherboard arm to said worktable includes a means for lockably adjusting the position of said featherboard arm with respect to said worktable.

18. The work piece guide of claim 15 wherein the means for temporarily securing said featherboard arm to said worktable comprises:
a) an angled mounting bracket having one or more mounting holes formed therein;
b) an arm guide, secured to said angled mounting bracket for slidably retaining said featherboard arm, said arm guide having a threaded hole formed therein; and
c) a locking knob, having a threaded post formed thereon for threadably engaging the threaded hole on said arm guide, wherein when said threaded post on said locking knob engages said featherboard arm, said featherboard arm is locked in place.

19. The work piece guide of claim 18 further comprising one or more standoffs, in number equaling the number of mounting holes in said angled mounting bracket, adjustably secured to angled mounting bracket and extending downwards therefrom, whereby said standoffs engage a corresponding number of holes formed in said worktable such that when said standoffs are in said holes on said worktable, the work piece guide is firmly, yet temporarily, attached to said worktable.

20. The work piece guide of claim 15 wherein the means for temporarily securing said featherboard arm to said worktable comprises:
a) a flat mounting plate having a plurality of mounting holes formed therein;
b) an arm guide, secured to said flat mounting plate for slidably retaining said featherboard arm, said arm guide having a threaded holed formed therein; and
c) a locking knob, having a threaded post formed thereon for threadably engaging the threaded hole on said arm guide, wherein when said threaded post on said locking knob engages said featherboard arm, said featherboard arm is locked in place.

21. The work piece guide of claim 20 further comprising a plurality of standoffs, adjustably secured to flat mounting plate and extending downwards therefrom, whereby said standoffs engage a corresponding plurality of holes formed in said worktable such that when said standoffs are in said holes on said worktable, the work piece guide is firmly, yet temporarily, attached to said worktable.
